(19) United States
(12) Patent Application Publication
(10) Pub. No.: US 2021/0152746 A1
(43) Pub. Date: May 20, 2021

(54) SOLAR WIRELESS VISUAL REVERSING SYSTEM

(71) Applicant: Yuhua WANG, Beijing (CN)

(72) Inventor: Yuhua WANG, Beijing (CN)

(21) Appl. No.: 17/256,345

(22) PCT Filed: Sep. 12, 2019
(86) PCT No.: PCT/CN2019/095769

§ 371 Date: Dec. 28, 2020

(30) Foreign Application Priority Data
Jul. 19, 2018 (CN) 201821142876.X

(51) Int. Cl. H04N 5/232; H04N 7/18; G01P 15/00; G01S 13/08; G01S 13/931; G01P 13/00; B60R 1/00

(52) U.S. Cl. CPC H04N 5/232411; H04N 5/23203; H04N 7/188; H04N 5/23299; H04N 7/183; B60R 2300/20; G01S 13/08; G01S 13/931; G01P 13/00; B60R 1/00; B60R 2300/10; G01P 15/00

(57) ABSTRACT

A solar wireless visual reversing system including an inboard host and an outboard host is provided, the inboard host includes a first casing as well as a display screen device, a distance sensor, a first master control circuit device and a first wireless communication module provided in first casing, the display screen device, the first wireless communication module and the distance sensor respectively connected to the first master control circuit device; the outboard host includes a second casing as well as a camera, a solar panel, a storage battery, a second master control circuit device, an acceleration sensor and a second wireless communication module provided in the second casing, the camera, the solar panel, the storage battery, the second wireless communication module and the acceleration sensor respectively connected to the second master control circuit device; and the inboard host and the outboard host wirelessly transmit commands and image data respectively.

### TECHNICAL FIELD

The present disclosure relates to a wireless visual reversing system, and particularly relates to a solar wireless visual reversing system using solar energy as a source of electric energy.

### BACKGROUND ART

A wireless visual reversing system in which a camera is normally mounted at a tail part of a vehicle and video signals acquired by the camera are wirelessly transmitted to a display in the vehicle has been known. A driver can view the situation behind the vehicle through the display, and thus driving safety and parking convenience are improved. However, if the system has not been installed in the vehicle by the time of ex-factory delivery, in order to additionally install the system later, a user will have to disassemble relevant parts of the vehicle, lay a wire to supply power to the camera, and even punch or drill a hole in a body of the vehicle, which brings a lot of inconvenience.

### SUMMARY In order to overcome the above defects, the present disclosure provides a solar wireless visual reversing system which adopts the following technical solutions:

A solar wireless visual reversing system comprises an inboard host and an outboard host, wherein the inboard host includes a first casing as well as a first master control circuit device, a display screen device, a distance sensor and a first wireless communication module provided in first casing, the display screen device, the first wireless communication module and the distance sensor being respectively connected to the first master control circuit device; wherein the outboard host includes a second casing as well as a camera, a solar panel, a storage battery, a second master control circuit device, an acceleration sensor and a second wireless communication module provided in the second casing, the camera, the solar panel, the storage battery, the second wireless communication module and the acceleration sensor being respectively connected to the second master control circuit device; and wherein the inboard host and the outboard host wirelessly transmit command information and image data respectively.

Wherein, the first master control circuit device of the inboard host is configured to: instruct the first wireless communication module to transmit a command to the outboard host when the inboard host is powered on or the distance sensor detects an object capable of generating reflected waves within a sensible range of the distance sensor; activate, upon receipt of image information transmitted from the second wireless communication module of the outboard host, the display screen device to display the image, and turn off the display screen when no image information is received within a specified duration of seconds.

Wherein, the second master control circuit device of the outboard host is configured to: activate, upon receipt of a command transmitted from the first wireless communication module of the inboard host, the camera and the second wireless communication module and transmit image information picked up to the inboard host; turn off the camera when a working time of the camera reaches a specified duration of seconds; and bring the outboard host into a standby state when the acceleration sensor detects a vibration or movement of the vehicle.

Wherein, when the distance sensor of the inboard host detects an object capable of generating reflected waves within a sensible range of the distance sensor, a command is transmitted to the outboard host by the first wireless communication module so that the outboard host activates the camera to pick up images upon receiving the command, and transmits image data picked up to the inboard host by the second wireless communication module.

Wherein, a fixed time period of seconds is preset so that the outboard host only transmits image data with a length of time equal to the fixed time period of seconds to the inboard host each time when the outboard host receives a command, and the transmission is automatically terminated when it is finished.

Wherein, when the acceleration sensor of the outboard host detects a vibration or movement of the vehicle, the outboard host is brought into a standby state to wait for a command from the inboard host, and when no vibration or movement of the vehicle is detected by the acceleration sensor within a preset time period, the outboard host is brought into a sleep state for saving power and no longer receives any command from the inboard host.

Wherein, the second casing of the outboard host is provided with a license plate frame configuration and devices installed at a tail part of a vehicle, the license plate frame configuration has a shape and a size consistent with those of a vehicle license plate, a spare space for exposing a license plate number being provided in a central region of the license plate frame configuration, and a space for receiving the camera, the solar panel, the storage battery, the second master control circuit device, the acceleration sensor and the second wireless communication module being formed around the spare space.

Wherein, an infrared distance sensor, or an ultrasonic distance sensor, or a laser distance sensor is used as the distance sensor of the inboard host.

Wherein, the camera in the second casing of the outboard host is provided with a rotation mechanism for adjusting a pickup angle of the camera.

Wherein, the rotation mechanism for adjusting the pickup angle of the camera includes a horizontal swaying rotation mechanism and a vertical tilting rotation mechanism, and the rotation mechanism further includes a locking mechanism for locking the camera at a selected pickup angle.

In view of the defects in the prior art, a solar cell is used to supply power to a camera, which leads to more convenient installation and use. In addition, power saving can be achieved by reasonably configuring an interactive mode between the inboard host and the outboard host.

### BRIEF DESCRIPTION OF THE DRAWINGS

FIG. 1 shows an inboard host of a solar wireless visual reversing system according to the present disclosure.

FIG. 2 shows an outboard host of a solar wireless visual reversing system according to the present disclosure.

FIG. 3 is a schematic block diagram of an inboard host of a solar wireless visual reversing system according to the present disclosure.

FIG. 4 is a schematic block diagram of an outboard host of a solar wireless visual reversing system according to the present disclosure.

### MEANINGS OF REFERENCE SIGNS IN THE DRAWINGS

1. inboard host

2. outboard host

11. first casing

12. display screen device

13. distance sensor

14. first wireless communication module

21. second casing

22. camera device

23. solar panel

24. storage battery

25. first master control circuit device

25′. second master control circuit device

26. acceleration sensor

27. second wireless communication module

28. spare space for exposing a license plate number

29. mounting holes of the outboard host.

### DETAILED DESCRIPTION OF THE EMBODIMENTS

Hereinafter, embodiments of the present application will be described in detail with reference to the drawings.

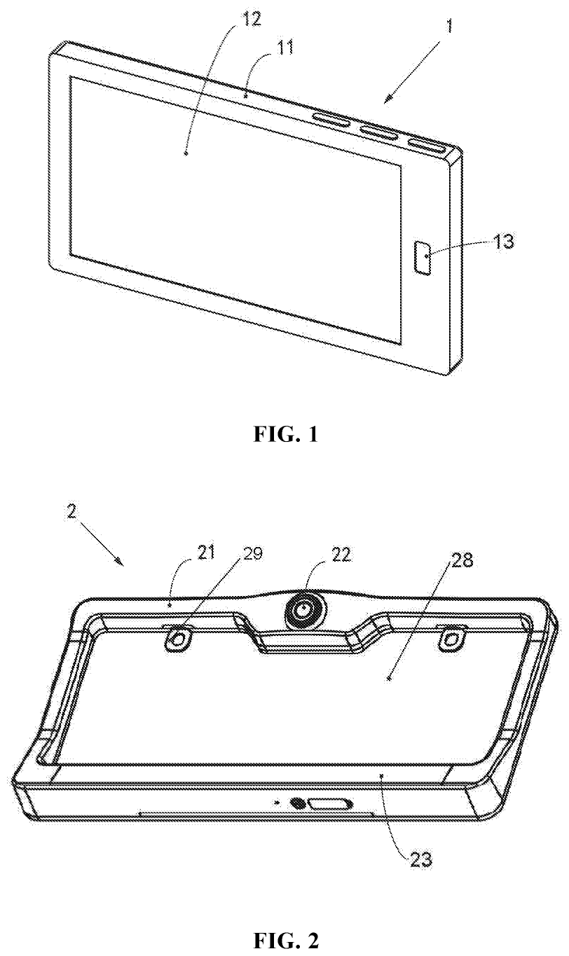

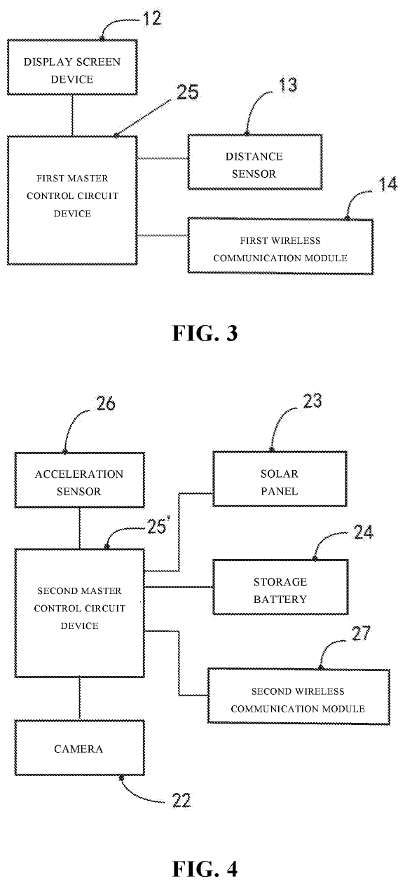

The present disclosure provides a solar wireless visual reversing system which, as shown in the FIGS. 1-4, includes an inboard host 1 and an outboard host 2. The inboard host 1 includes a first casing 11 as well as a display screen device 12, a distance sensor 13, a first master control circuit device 25 and a first wireless communication module 14 provided in the first casing 11. The first wireless communication module 14, the display screen device 12, and the distance sensor 13 are respectively connected to the first master control circuit device 25. The outboard host 2 includes a second casing 21 as well as a camera 22, a solar panel 23, a storage battery 24, a second master control circuit device 25′, an acceleration sensor 26 and a second wireless communication module 27 provided in the second casing 21. The camera 22, the solar panel 23, the storage battery 24, the acceleration sensor 26 and the second wireless communication module 27 are respectively connected to the second master control circuit device 25′. The inboard host 1 and the outboard host 2 wirelessly transmit command information and image information data respectively.

The first master control circuit device 25 of the inboard host 1 is configured to: instruct the first wireless communication module 14 to transmit a command to the outboard host 2 when the inboard host 1 is powered on or the distance sensor 13 detects an object capable of generating reflected waves within a sensible range of the distance sensor 13; activate, upon receipt of image information transmitted from the second wireless communication module 27 of the outboard host 2, the display screen device 12 to display the image; and turn off the display screen device 12 when no image information is received within a specified duration of seconds.

The second master control circuit device 25′ of the outboard host 2 is configured to: activate, upon receipt of a command transmitted from the first wireless communication module 14 of the inboard host 1, the camera 22 and the second wireless communication module 27 and transmit image information picked up to the inboard host 1; turn off the camera 22 when a working time of the camera 22 reaches a specified duration of seconds; and bring the outboard host 2 into a standby state when the acceleration sensor 26 detects a vibration or movement of a vehicle.

The inboard host 1 may be installed on a windshield or a dashboard in front of a driver inside a vehicle via an installation bracket to facilitate the driver's use and operation. A power supply of the inboard host 1 may be available from a socket of a cigarette lighter of the vehicle or be obtained in other manners. The outboard host 2 is provided outside the vehicle at the back of the vehicle (in the rear of the vehicle), and since the solar panel 23 is used as a source of electric energy, it is not necessary to disassembly the vehicle at relevant positions to get electricity from a circuit inside the vehicle, thereby greatly reducing damage to a vehicle body. The outboard host 2 may be installed onto the vehicle through a double-sided adhesive tape, a magnet, or other means. After the outboard host 2 is installed, the solar panel 23 starts to generate electricity when an intensity of the ambient light reaches a light intensity required by the solar panel 23 to operate, and the generated electricity is stored in the storage battery 24. Due to a limited amount of electricity generated by the solar panel 23, the outboard host 2 of the present disclosure provides several improvements in saving power, enabling the solar wireless visual reversing system to be implemented in practice.

Examples of a workflow of the solar wireless visual reversing system according to the present disclosure are given as follows:

1) When a vehicle is shut down and parked to be stationary after the previous use, the inboard host 1 is powered off. When no vibration or movement of the vehicle is detected by the acceleration sensor 26 of the outboard host 2 for a specified long time period (e.g., 30 minutes, or other number of minutes), the outboard host 2 is brought into an energy-saving state. At this time, the second wireless communication module 27 and the camera 22 are withdrawn from a standby state. Meanwhile, the outboard host 2 is brought into a sleep state for saving power, and no longer receives any command from the inboard host 1. Then, only the acceleration sensor 26 of the outboard host 2 is in a standby state while other components of the outboard host 2 are in a sleep state, thus involving a very low power consumption.

2) When a driver opens a door of the vehicle to sit into the vehicle and prepares for driving, the acceleration sensor 26 of the outboard host 2 detects a vibration or movement of the vehicle body caused by an action of the driver, and then, the outboard host 2 is brought into a standby state from the sleep state to wait for a command from the inboard host 1.

3) When the driver starts up the vehicle, at which time the inboard host 1 obtains power from an electric system of the vehicle, the inboard host 1 is powered on and automatically transmits a command at a time to the outboard host 2 through the first wireless communication module 14 to obtain image information behind the vehicle. After receiving the command, the outboard host 2 activates the camera 22 and transmits image information picked up by the camera 22 to the inboard host 1 through the second wireless communication module 27, and the image is displayed to the driver via the display screen device 12 so that the driver can conveniently know the situation behind the vehicle. In order to save power, after a preset duration of seconds, such as 30 seconds (or other number of seconds), the outboard host 2 turns off the camera 22 and terminates the image transmission, while the display screen 12 of the inboard host 1 is automatically turned off.

4) The distance sensor 13 of the inboard host 1 is configured to detect whether an object (such as a waving human hand or other objects) capable of generating reflected waves is present within a sensible range of the distance sensor 13. When the driver needs to view an image behind the vehicle during travelling of the vehicle or when the driver intends to park the vehicle in a parking space, the driver is only required to shield the inboard host 1 and wave a hand (or other objects) in front of the inboard host 1 so that when the distance sensor 13 detects the object within the sensible range of the distance sensor 13, it is determined that the driver wants to view the image behind the vehicle. At this moment, a command is transmitted to the outboard host 2 through the first wireless communication module 14 to obtain the image behind the vehicle. After receiving the command, the outboard host 2 activates the camera 22 and wirelessly transmits the image data picked up by the camera 22 to the inboard host 1, while the display screen device 12 is automatically activated and displays the image to the driver so that the driver can conveniently know the situation behind the vehicle. In order to save power, after a preset duration of seconds, such as 30 seconds (or other number of seconds), the outboard host 2 turns off the camera 22 and terminates the image transmission, while the display screen 12 of the inboard host 1 is automatically turned off.

In a preferred embodiment, the second casing 21 of the outboard host 2 is provided with a license plate frame configuration and devices installed at a tail part of the vehicle. The license plate frame configuration has a shape and a size consistent with those of a vehicle license plate as well as mounting holes 29 coinciding with the license plate, a spare space 28 for exposing a license plate number is provided in a central region of the license plate frame configuration, and a space for receiving the camera 22, the solar panel 23, the storage battery 24, the second master control circuit device 25′, the acceleration sensor 26 and the second wireless communication module 27 is formed around the spare space. The space is made by an elongated strip that is bent in turn by 90 degrees to form a rectangular frame shape consistent with that of the license plate. When the respective components are arranged in the space, it goes without saying that the camera 22 should be in place at a suitable pickup angle. Further, the solar panel 23 should be placed in a position where the maximum sunlight is accessible. The entire outboard host 2 is desired to be waterproof and weather-resistant.

In the solar wireless visual reversing system of the present disclosure, an infrared distance sensor, or an ultrasonic distance sensor, or a laser distance sensor may be used as the distance sensor 13 of the inboard host 1.

The camera 22 in the second casing 21 of the outboard host 2 may be further designed to have a rotation mechanism for adjusting a pickup angle of the camera so that the camera is directed to an object to be picked up. The rotation mechanism may include a horizontal swaying rotation mechanism and a vertical tilting rotation mechanism, and the rotation mechanism may further include a locking mechanism (not shown in the drawings) for locking the camera at a selected pickup angle.

1. A solar wireless visual reversing system comprising an inboard host and an outboard host, characterized in that
the inboard host comprises a first casing as well as a first master control circuit device, a display screen device, a distance sensor and a first wireless communication module provided in the first casing, the display screen device, the first wireless communication module and the distance sensor being respectively connected to the first master control circuit device;
the outboard host comprises a second casing as well as a camera, a solar panel, a storage battery, a second master control circuit device, an acceleration sensor and a second wireless communication module provided in the second casing, the camera, the solar panel, the storage battery, the second wireless communication module and the acceleration sensor being respectively connected to the second master control circuit device; and
the inboard host and the outboard host wirelessly transmit command information and image data respectively.

2. The solar wireless visual reversing system of claim 1, wherein the first master control circuit device of the inboard host is configured to: instruct the first wireless communication module to transmit a command to the outboard host when the inboard host is powered on or the distance sensor detects an object capable of generating reflected waves within a sensible range of the distance sensor; activate, upon receipt of image information transmitted from the second wireless communication module of the outboard host, the display screen device to display the image, and turn off the display screen when no image information is received within a specified duration of seconds.

3. The solar wireless visual reversing system of claim 1, wherein the second master control circuit device of the outboard host is configured to: activate, upon receipt of a command transmitted from the first wireless communication module of the inboard host, the camera and the second wireless communication module and transmit image information picked up to the inboard host; turn off the camera when a working time of the camera reaches a specified duration of seconds;
and bring the outboard host into a standby state when the acceleration sensor detects a vibration or movement of a vehicle.

4. The solar wireless visual reversing system of claim 1, wherein when the distance sensor of the inboard host detects an object capable of generating reflected waves within a sensible range of the distance sensor, a command is transmitted to the outboard host by the first wireless communication module so that the outboard host activates the camera to pick up images upon receiving the command and transmits image data picked up to the inboard host by the second wireless communication module.

5. The solar wireless visual reversing system of claim 1, wherein a fixed time period of seconds is preset so that the outboard host only transmits image data with a length of time equal to the fixed time period of seconds to the inboard host each time when the outboard host receives a command, and the transmission is automatically terminated when it is finished.

6. The solar wireless visual reversing system of claim 1, wherein when the acceleration sensor of the outboard host detects a vibration or movement of a vehicle, the outboard host is brought into a standby state to wait for a command from the inboard host, and when no vibration or movement of the vehicle is detected by the acceleration sensor within a preset time period, the outboard host is brought into a sleep state for saving power and no longer receives any command from the inboard host.

7. The solar wireless visual reversing system of claim 1, wherein the second casing of the outboard host has a license plate frame configuration, the license plate frame configuration has a shape and a size consistent with those of a vehicle license plate, a spare space for exposing a license plate number being provided in a central region of the license plate frame configuration, and a space for receiving the camera, the solar panel, the storage battery, the second master control circuit device, the acceleration sensor and the second wireless communication module being formed around the spare space.

8. The solar wireless visual reversing system of claim 1, wherein an infrared distance sensor, or an ultrasonic distance sensor, or a laser distance sensor is used as the distance sensor of the inboard host.

9. The solar wireless visual reversing system of claim 1, wherein the camera in the second casing of the outboard host is provided with a rotation mechanism for adjusting a pickup angle of the camera.

10. The solar wireless visual reversing system of claim 9, wherein the rotation mechanism for adjusting the pickup angle of the camera comprises a horizontal swaying rotation mechanism and a vertical tilting rotation mechanism, and the rotation mechanism further comprises a locking mechanism for locking the camera at a selected pickup angle.

11. A method for using a solar wireless visual reversing system comprising an inboard host and an outboard host, wherein
the inboard host comprises a first master control circuit device, a display screen device, a distance sensor and a first wireless communication module, the display screen device, the first wireless communication module and the distance sensor being respectively connected to the first master control circuit device;
the outboard host comprises a camera, a solar panel, a storage battery, a second master control circuit device, an acceleration sensor and a second wireless communication module, the camera, the solar panel, the storage battery, the second wireless communication module and the acceleration sensor being respectively connected to the second master control circuit device; and
the inboard host and the outboard host wirelessly transmit command information and image data respectively,
wherein the method comprises the following steps:
a) when a vehicle is shut down and parked, powering off the inboard host;
when no vibration or movement of the vehicle is detected by the acceleration sensor of the outboard host for a specified time period, bringing the outboard host into an energy-saving state; at this time, the second wireless communication module and the camera are withdrawn from a standby state; meanwhile, the outboard host is brought into a sleep state for saving power and no longer receives any command from the inboard host; then, only the acceleration sensor of the outboard host is in a standby state while other components of the outboard host are in a sleep state; and
b) when a driver opens a door of the vehicle to sit into the vehicle and prepares for driving, causing the acceleration sensor of the outboard host to detect a vibration or movement of a vehicle body caused by an action of the driver, and then, bringing the outboard host into a standby state from the sleep state to wait for a command from the inboard host.

12. The method of claim 11, further comprising the step of
c) when the driver starts up the vehicle, at which time the inboard host obtains power from an electric system of the vehicle, powering on the inboard host and causing the inboard host to automatically transmit a command at a time to the outboard host through the first wireless communication module to obtain image information behind the vehicle; after the command is received, causing the outboard host to activate the camera, transmit image information picked up by the camera to the inboard host through the second wireless communication module, and display the image to the driver via the display screen device.

13. The method of claim 12, further comprising the step of
d) configuring the distance sensor of the inboard host to detect whether an object capable of generating reflected waves is present within a sensible range of the distance sensor; when it is desired to view an image behind the vehicle during travelling of the vehicle, just shielding the inboard host and waving an object in front of the inboard host so that when the distance sensor detects the object within the sensible range of the distance sensor, determining that the driver wants to view the image behind the vehicle; at this moment, a command is transmitted to the outboard host through the first wireless communication module to obtain the image behind the vehicle; after the command is received, causing the outboard host to activate the camera and wirelessly transmit the image data picked up by the camera to the inboard host, and automatically activate the display screen device to display the image to the driver.

14. The method of claim 12, wherein after a preset duration of seconds, causing the outboard host to turn off the camera and terminate the image transmission, and automatically turning off the display screen of the inboard host.

15. The method of claim 13, wherein after a preset duration of seconds, causing the outboard host to turn off the camera and terminate the image transmission, and automatically turning off the display screen of the inboard host.
